(19) United States
(12) Patent Application Publication
(10) Pub. No.: US 2005/0149880 A1
(43) Pub. Date: Jul. 7, 2005

(54) Method and system for user control of secondary content displayed on a computing device

(76) Inventor: Richard Postrel, Miami Beach, FL (US)

Correspondence Address: ANTHONY R BARKUME, 20 GATEWAY LANE, MANORVILLE, NY, 11949, US

(21) Appl. No.: 10/981,382

(22) Filed: Nov. 4, 2004

Related U.S. Application Data
(60) Provisional application No. 60/517,689, filed on Nov. 6, 2003.

(51) Int. Cl. G06F 3/00; G06F 17/60

(52) U.S. Cl. 715/808; 705/14; 715/809; 715/811; 715/789; 715/844; 715/814

(57) ABSTRACT

A method of and system for managing online content wherein a user views primary content on a display device associated with a user computing device interconnected to a computer network. A content server computer interconnected to the computer network provides secondary content to the user computing device for display on the display device. The user computing device receives the secondary content provided by the content server computer and performs a function with respect to the secondary content that controls the disposition of the secondary content while maintaining display of the primary content on the display device.

### CROSS-REFERENCE TO RELATED APPLICATION

This application claims filing priority of co-pending U.S. provisional patent application Ser. No. 60/517,689, filed on Nov. 6, 2003.

### BACKGROUND OF THE INVENTION

The present invention relates to secondary web content that is pushed to a user (and/or pulled by a user along with primary content), such as banner and pop-up advertisements, email messages and instant messages, and in particular to such secondary content that can be controlled by the user as described herein.

Banner ads and pop-up windows are ubiquitous tools for displaying secondary content such as advertisements and the like to users along with the primary content web pages they are viewing. A typical banner ad is served at the top of a web page, and may be related to the content of the web page and/or a profile of the user. For example, when a 30 year old male is viewing the ESPN.com web site, a banner ad for football jerseys may be served and displayed to the user; while a 65 year old woman viewing a gardening web site may be served an ad for a retirement magazine. This is referred to herein as secondary content since it includes web content that is not primary to the user; i.e. it is not content that the user has specifically requested for viewing.

If a user is interested in the subject matter of the secondary content, he or she will use an input device such as a mouse to click on the display area covered by the secondary content and a new browser window may open with more content related to that banner ad. Alternatively, the currently open browser will link to the new web site referred to by the secondary content instead of a new window being opened. In any event, the user, who has some interest in the secondary content, is led away from the primary content web page he was viewing in a very distracting manner. Someone working on a research project may have some interest in the secondary content but will have a serious disruption of his work process, or may even be unable to navigate back to the primary content web site he was viewing prior to clicking through the ad. However, if the user does not click on the secondary content at that time he may lose the ability to get back to it later on since different secondary content may be served the next time he views the same web page, as is common practice in the industry. Thus, the web user is at a major disadvantage regardless of his choice.

Secondary content in the form of a pop-up ad is similar to a banner ad but may already be shown in a separate window. The same annoyances described above also exist for pop-up ads. They are even further annoying to a user since the new window must be closed by the user to remove it from his display screen and continue to work with the primary content, while a banner ad is only secondary content contained within a primary content page.

Thus, both types of secondary content are distracting to most users. Even if the users are interested in the secondary content, the likelihood is small that they will click through at the time the ad is served since it will distract them from their intended work.

One solution that is available today is the use of a pop-up blocker program, such one available from Google.com. This software will act to block all pop-up windows from appearing on the user's display device, regardless of their content. The Google.com pop-up blocker allows a user to indicate if a certain content server is allowed to push pop-up ads to the screen or not; this setting may be changed by clicking an option button on the Google.com toolbar. This is highly disadvantageous since it is only a “go/no-go” control. If a user thinks that he may want to receive pop-ups from a certain web site, he has to enable all pop-ups to be displayed from that web site, or turn pop-ups off completely from that web site. This provides a user with limited functionality. In addition, this function is not useful with respect to secondary content that is pushed to a user that does not appear in the form of a pop-up ad, such as a simple banner ad embedded in the primary content web page pulled by the user. The present invention addresses these types of secondary content as well.

This secondary content as explained herein is also referred to as pushed content since it is pushed by a content server over the Internet to a user that has not requested the content. In contrast, the user is considered to have pulled the primary content; that is, he or she has voluntarily requested the web page by typing a URL, clicking a hyperlink within another web page, etc. It is an object of the present invention to provide a user with the ability to easily manage secondary content that has been pushed to his computer in a manner that does not disrupt his work with the pulled primary content yet allows him to explore the secondary content, if desired, at a later time when it is more convenient, as fully described herein.

### SUMMARY OF THE INVENTION

Thus, the present invention is a method of and system for managing online content wherein a user views a display device associated with a user computing device interconnected to a computer network. A content server computer interconnected to the computer network provides content to the user computing device, which includes secondary content for display on the display device. The user computing device receives the secondary content provided by the content server computer and performs a function with respect to the secondary content that controls the disposition of the secondary content while maintaining display of the primary content on the display device.

The function may be defined in a default profile that may be stored on the user computing device that may be automatically performed by the user computing device as a result of receiving the secondary content. Optionally, the user may be notified that secondary content has been received, and then requested to either allow the default function to be automatically performed or to allow the secondary content to be displayed on the display device. In the event that secondary content is allowed to be displayed on the display device, then the user may use an input device associated with the user computing device to interact with the secondary content to perform a function controlling disposition of the secondary content.

As an alternative, a menu may be displayed that has a plurality of functions available for controlling the disposition of the secondary content. The user selects a function from the menu and the selected function is then utilized by the user computing device to control the disposition of the secondary content on the display device. The menu may be included with as part of the secondary content provided by the content server computer and displayed on the display device. The menu may be displayed on the display device by a user interaction with the secondary content, such as a right-click of a mouse input device.

The secondary content may include an advertisement, an instant message, an email message, destination-specific content, and/or time-specific content. The functions that may be performed on the secondary content include storing the secondary content in a folder system on a data storage device in the user computing device, wherein the secondary content may be sorted; for example, according to topic, according to the sponsor of the secondary content, or according to the time and/or day the secondary content has been received. Another function that may be performed is mapping the secondary content to an icon and placing the icon in a designated area in the display, wherein the icon may be color-coded (or otherwise marked) in accordance with a predetermined scheme related to a degree of interest indicated by the user. Another function that may be performed is linking the secondary content to a reminder file, wherein the reminder file specifies a subsequent time at which the user wishes to receive a reminder to view the secondary content.

Another function that may be performed is executing a blocking routine that may for example specify that all secondary content from a defined content server computer will be blocked from being received by the user computing device. The blocking routine may also specify that secondary content related to a defined topic from any content server computer will be blocked from being received by the user computing device, or it may specify that all secondary content from any content server computer will be blocked from being received by the user computing device only during a defined time period or only on certain days.

Other functions that may be performed include executing a delay routine wherein the secondary content is removed from the display device for a time period after which it is automatically re-displayed on the display device, sending a request to the content server computer for additional content relevant to the secondary content, and/or causing the secondary content to be continuously displayed (i.e. frozen) on the display device until selected by the user to be removed from display on the display device.

The content server computer may be a service provider in accordance with this invention and be adapted to log the request sent by the user computing device and send the requested additional content to the user computing device. A user profile may then be generated based on the requests received by the content server computer. Additional secondary content may also be generated for subsequent transmission to the user computing device based on the user profile. Furthermore, additional information may be obtained from a user via the user computing device and the additional information is then added to the user profile.

The content server computer and/or secondary content server computer may be operated as a service by a service provider such as an advertising agency or a search engine provider as described more fully herein. A rate structure may be established for charging a sponsor of the secondary content based upon information collected from the user computing device regarding an action taken by the user with respect to the secondary content. The rate structure may for example be multi-tiered, having a first tier based upon delivery of secondary content to a user computing device, a second tier based upon a first action taken by a user with respect to the secondary content, and a third tier based upon a request made by the user for additional information relevant to the secondary content.

In one embodiment, secondary content such as a pop-up ad will appear as a transient cloud, which appears briefly and then disappears from sight in a certain time frame. A user will know from past experience that the cloud is indicative of the transient nature of the ad, and may be more inclined to right-click and save it for later viewing. This methodology will operate to alert users that the ad should be paid attention to quickly since it will disappear very soon (e.g. in ten seconds).

The ads may also be right-clicked and saved in a folder, similar to a Favorites or Bookmarks folder. A special folder may be created in the user's desktop application such as OUTLOOK, so that the ads appear as email messages that may be viewed at the user's leisure.

The present invention may be applied to other types of information as well. In any instance where a user receives information outside of his window of focus (i.e. the window in which he is working, such as a web page, spreadsheet, database form, etc.), then he may select that piece of information, which is typically but not always in the form of a new window, to be reduced to an icon as described above and moved to the edge of the display for subsequent selection and review when the user is ready to perform such review. Thus, in another example, a user may have a background process executing that takes certain keywords from a document in the user's main window of focus and performs searches on such keywords, returning searching results in pop-up windows or the like. The user may want to review them in depth at a later time, so he would select the window for saving at the edge of the display (or any of the other options described above). In this case, the icon may display the search term to enable the user to easily find which one he may want to select later on.

### BRIEF DESCRIPTION OF THE DRAWING

FIG. 1 is an illustration of an embodiment of the present invention that utilizes a menu of available functions for controlling disposition of secondary content;

FIG. 2 is an illustration of a first set of sub-menus of available functions for controlling disposition of secondary content in the embodiment illustrated in FIG. 1;

FIG. 3 is an illustration of a second set of sub-menus of available functions for controlling disposition of secondary content in the embodiment illustrated in FIG. 1;

FIG. 4 is an illustration of a third set of sub-menus of available functions for controlling disposition of secondary content in the embodiment illustrated in FIG. 1;

FIG. 5 is an illustration of a fourth set of sub-menus of available functions for controlling disposition of secondary content in the embodiment illustrated in FIG. 1;

FIG. 6 is an illustration of a fifth set of sub-menus of available functions for controlling disposition of secondary content in the embodiment illustrated in FIG. 1;

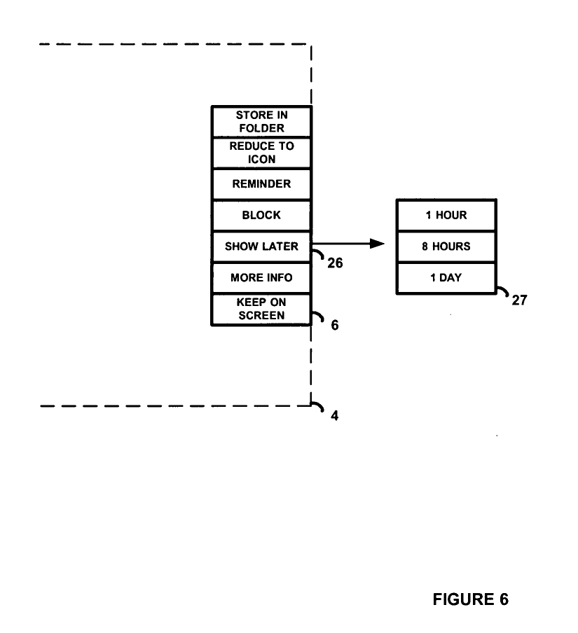

FIG. 7 is a flowchart of the operation of a preferred embodiment of the present invention;

FIG. 8 is a block diagram of the preferred embodiment of the present invention;

### DETAILED DESCRIPTION OF THE PREFERRED EMBODIMENT

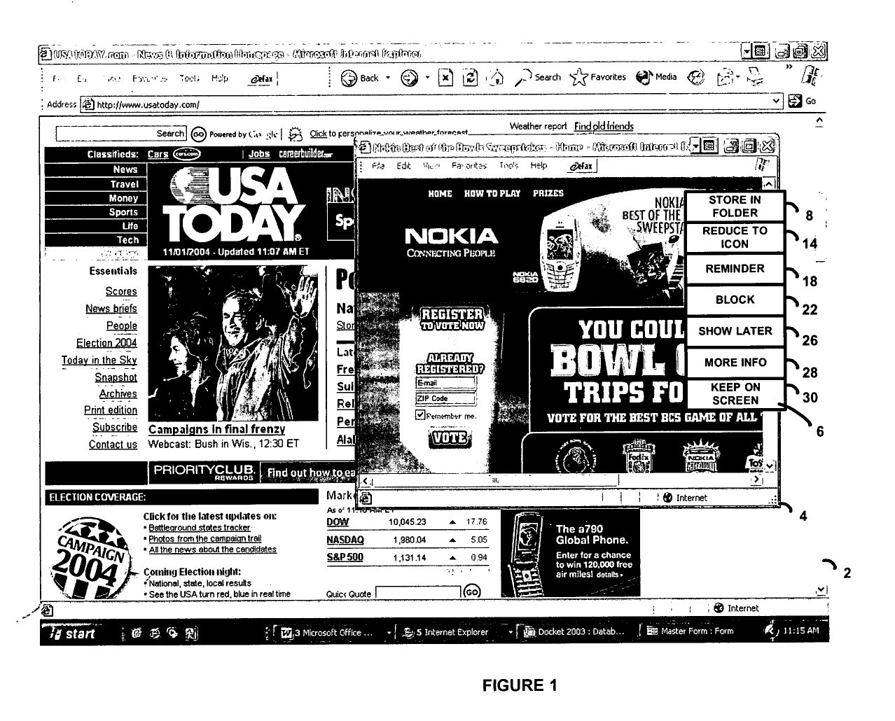

As will be described in detail herein, the present invention allows a user who is viewing or otherwise interacting with primary content, such as a web page retrieved from a web server over the Internet, to control and manage secondary content after it is received and displayed on his display device, or even prior to display. FIG. 1 illustrates a typical screen of a computer display device in accordance with this invention. FIG. 1 shows a primary content area 2 that contains primary web content, which in this example is a web page retrieved from http://www.usatoday.com. A user that has pulled the primary content usatoday.com web page is also provided with a secondary content window 4 that contains secondary web content, which in this example is an advertisement for Super Bowl tickets sponsored by Nokia, a popular manufacturer of cellular phones. This is a typical scenario that web users encounter with increasing frequency; the annoying appearance of a pop-up window that interferes with the user's primary objective, i.e. viewing the primary content usatoday.com web page.

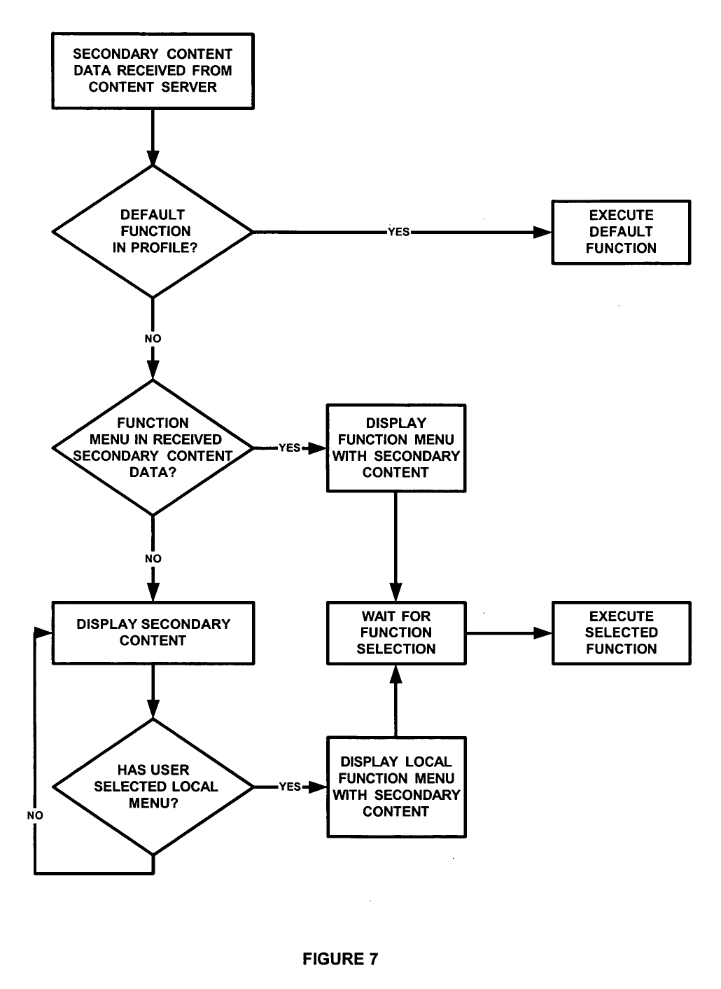

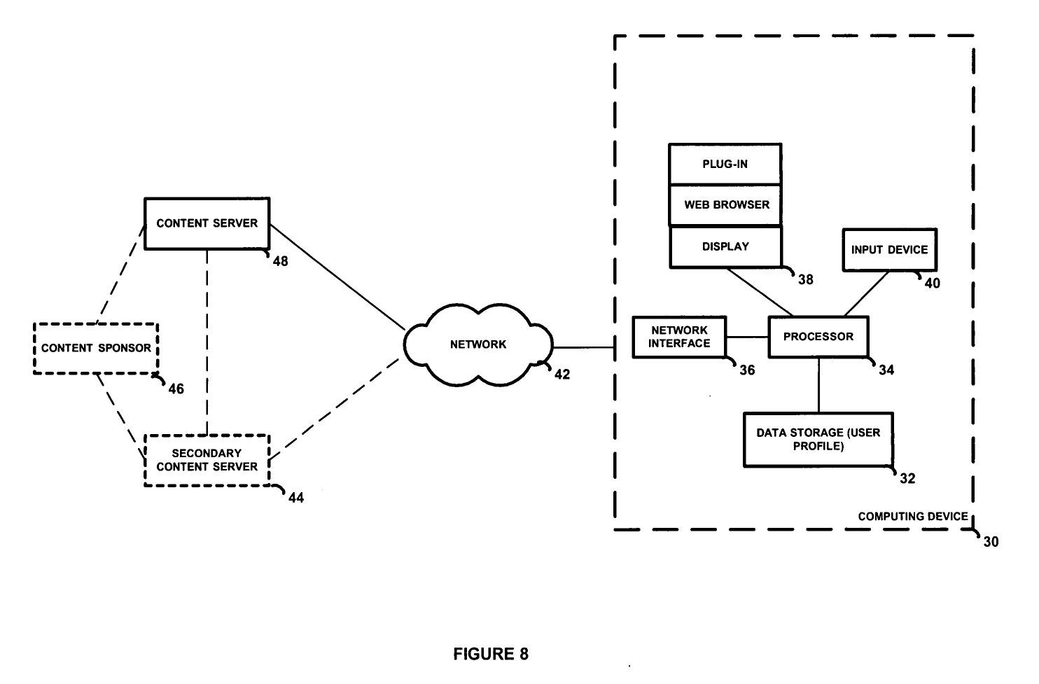

Reference is now also made to the flowchart illustrated in FIG. 7 and the system block diagram shown in FIG. 8. A user operating a user computing device 30 will request, or pull, primary web content from a content server 48 over a computer network such as the Internet 42 in a manner well known in the art. For example, the user may simply enter a URL, such as www.usatoday.com, in a browser window, or he may click on a hyperlink that leads him to the usatoday.com web site, etc. In any event, a URL that requests the usatoday.com web page is sent to the content server 48, and the content server returns the primary content page 2 as shown in FIG. 1 and as well known in the art.

In one case, secondary content is served along with the primary content from the content server 48. For example, an advertisement may simply be embedded within the primary content, and have a link associated with the area covered by the advertisement such that a user that clicks on the ad will be served with a web page linked thereto. For purposes of this invention this secondary content is considered to have been pushed to the user even though it is received along with the primary content pulled by the user.

In another scenario, secondary content in the form of a banner ad is served by a different computer over the network, which is termed a secondary content server. Services exist that will provide such banner ads, linked to primary content web pages, and either embed them in the primary content display 2 or cause a pop-up window to appear as shown in FIG. 1. As an example, a primary content web page may be served to a user, with an embedded reference to an advertising server computer. The user's browser will retrieve content from the advertising server computer per the embedded URL (aided in some situations by reference to a cookie on the user's computer) and receive the secondary content for placement in the primary content web page (or use as a pop up). Technologies have evolved that provide for various types of content to be displayed, played over speakers, and even movies are shown as advertisements. The present invention encompasses all such secondary content regardless of its exact form (audio, video, graphics, etc.) or its specific source (primary server, secondary server, etc.). The present invention also encompasses links as secondary content as well as the content to which the links may refer.

Thus, secondary content is received by the user computing device 30 through its network interface 36 as well known in the art. The processing circuitry 34 analyzes the incoming data stream and determines that part or all of the incoming data is considered to be secondary content. This may be done in several ways. In one case, the processor may look at the incoming data to determine if there are any hyperlinks, and if so it then flags the found links as secondary content. In another case, a service such as an advertising service operating under this invention may embed a flag or other data indicative of the presence of secondary content so that the user's computer may easily ascertain that secondary content has been received. This is especially useful when a service such as an advertising server is the entity that serves the secondary content. Other types of filters and content analysis routines may be employed to ascertain the presence of secondary content within the spirit and scope of the present invention. This may be done via a web browser plug-in program or the like.

Once the incoming content is flagged as being secondary content, the processor 34 first checks to determine if there has been a default function specified in a user profile, typically stored on a data storage device 32 as shown in FIG. 8. This default function may be pre-“established during a set-up routine by the user. As indicated, the default function will automatically be invoked once the receipt of secondary content has been established.

As an example, a default function may be the automatic storage of the secondary content in a folder system held on the data storage device 32 (e.g. hard drive) without displaying the secondary content on the primary content window 2. The secondary content would be made available to the user at a later time when it is more convenient for the user to view such secondary content. In a simple case, a folder may be labeled “Stored Ads” or the like, and a link to the secondary content (or the secondary content file itself) may be placed in the folder. The viewer may opt to periodically review the contents of the Stored Ads folder, and when he or she determines that new secondary content has been placed there, he may click on it to view it at his leisure. As a result, the user has not lost the secondary content (which may end up being desirable), but has automatically delayed viewing it until such time that he deems it convenient.

Optionally, an indicator may be placed on the screen to indicate in a non-obtrusive manner that secondary content has been diverted to a folder for later viewing. The nature of the indicator used may be a function of the type of secondary content that has been diverted. For example, when the secondary content is an embedded banner ad, a simple logo may be displayed in its place which cues the user to the diversion of the secondary content. In the alternative, a text message may be strategically placed on the display that simply states that an ad has been placed in a folder (a link to the folder may optionally be provided). In any event, the user may be signaled to the existence of new secondary content, or not signaled, as desired.

A setup wizard may be utilized as an aid for the user to configure certain parameters, such as a default function that would be carried out, etc.

In the event that a default function has not been specified, then the secondary content 4 will be displayed (or otherwise rendered, such as video or audio being played) along with the primary content 2 as shown in FIG. 1. Part of the present invention is the inclusion of a function menu 6 with the secondary content that is displayed along with the secondary content as shown in FIG. 1. This function menu may be included with the secondary content by the content server, for example. The function menu 6 will have one or more function buttons 8, 14, 18, 22, 26, 28, 30 displayed that will allow the user to make a desired selection as explained herein.

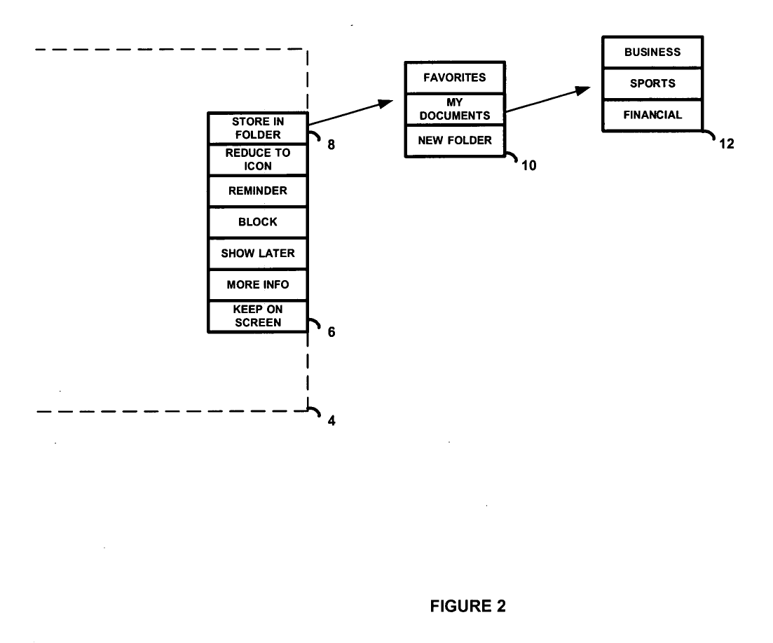

Function button 8 indicates the “Store in Folder” function, as shown in FIG. 2. The user may select this button 8, such as by clicking a mouse, touching the area on a touchscreen display, etc., and one of several events may happen. In a simple embodiment, the secondary content will be stored in a single folder, such as “Favorites”, “Bookmarks”, “My Secondary Content”, and the like. This will cause the secondary content to be removed from the primary content display and be stored in the default folder as indicated. In the alternative, a sub-menu system be be employed, wherein the user clicks on the top level button 8 and is provided with a first sub-menu 10 that has several options labeled “Favorites”, My Documents”, and “New Folder”. For example, if the user selects “Store in Folder”, and then “Favorites”, then the secondary content will be stored in the Favorites folder. Likewise, if “My Documents” is chosen then the secondary content will be stored in that folder, and the user can create a new folder by selecting “New Folder”. An additional sub-menu may appear such as when the user selects “My Documents” and the available folders are displayed as buttons 12: for example “Business”, “Sports”, and “Financial”. Secondary content may also be stored according to the sponsor of the content, according to the time the secondary content is received, and/or the day that the secondary content is received. As a result, the user may quickly cause the secondary content to be moved off of the primary content display and into any folder chosen for later viewing, by simply clicking the buttons, or hovering over them, touching them, etc.

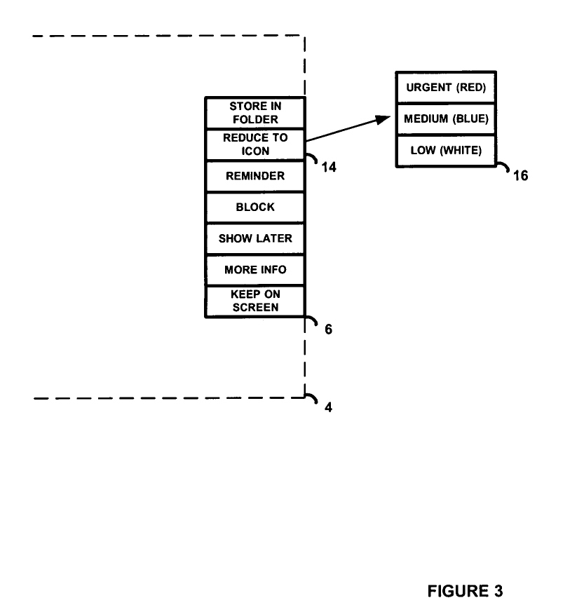

Function button 14 indicates the “Reduce to Icon” function, as shown in FIG. 3. The user may select this button 14, such as by clicking a mouse, touching the area on a touchscreen display, etc., and one of several events may happen. In a simple embodiment, the secondary content will be automatically stored in a temporary folder, and an icon will be generated and placed in a non-obtrusive area of the screen, such as in the system tray or toolbar, etc. This will cause the secondary content to be removed from the primary content display and be stored in the temporary folder as indicated. In the alternative, a sub-menu system be be employed, wherein the user clicks on the top level button 14 and is provided with a sub-menu 16 that has several options labeled “Urgent (Red)”, “Medium (Blue)”, and “Low (White)”. For example, if the user selects “Urgent (Red)”, then a red button indicating an urgent level of importance will be placed on the screen (in addition or in the alternative to using different colors, icons may have varying shapes or sizes to indicate the indicated level of importance to the user). As a result, the user may quickly cause the secondary content to be moved off of the primary content display, into a temporary folder, and an icon may be generated to indicate that the secondary content is available for later viewing.

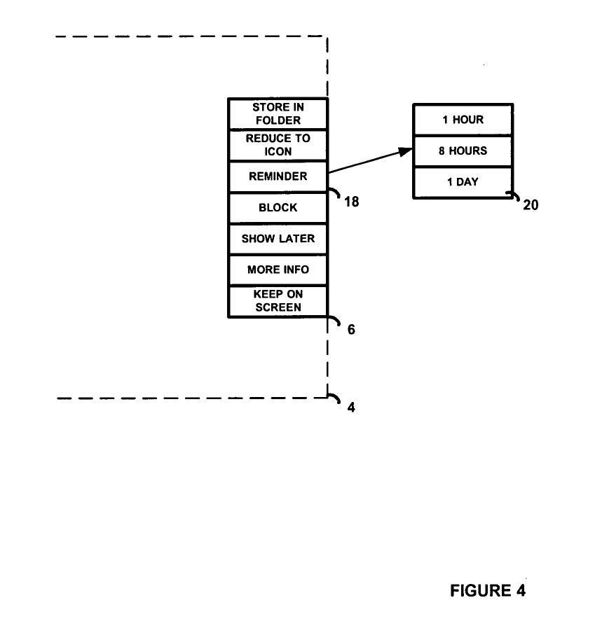

Function button 18 indicates the “Reminder” function, as shown in FIG. 4. The user may select this button 18 and one of several events may happen. In a simple embodiment, the secondary content will be stored in a single reminder folder and a predetermined time counter will begin. At the end of the count, a reminder will be displayed or played such that the user will be prompted to view the previously stored secondary content. The reminder may be reset if desired. In the alternative, a sub-menu system may be employed, wherein the user clicks on the top level button 18 and is provided with a sub-menu 20 that has several options labeled “1 Hour”, “8 Hours”, and “1 Day”. For example, if the user selects “Reminder”, and then “1 Day”, then the secondary content will be stored in a reminder folder and a reminder window will appear on the display one day later. As a result, the user may quickly cause the secondary content to be moved off of the primary content display and into a reminder folder for later viewing by selecting the desired function buttons.

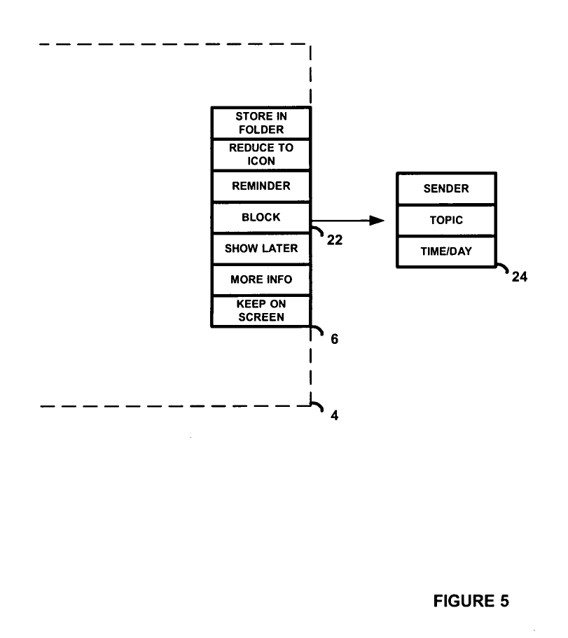

Function button 22 indicates the “Block” function, as shown in FIG. 5. The user may select this button 22 and one of several events may happen. In a simple embodiment, the secondary content will be blocked based on a predefined default association, such as sender, topic or time/day as described herein. This will cause the secondary content to be blocked and removed from the primary content display but not be stored in a folder as previously described. This also causes subsequently received secondary content to be blocked if the predefined association matches, such as if it is sent by the same sender (or same sponsor), or if it is related to the same topic (determined for example by reference to embedded metadata), or if it arrives at a specified time of day (e.g. between 9 AM-5 PM) or day of week (e.g. Monday through Friday). In the alternative to having a default blocking association, a sub-menu system be be employed, wherein the user clicks on the top level button 22 and is provided with a sub-menu 24 that has several options as described above. For example, if the user selects “Block”, and then “Topic”, then all secondary content subsequently received having the same topic will be blocked and removed permanently from the primary content display. As a result, the user may quickly cause the secondary content to be removed and subsequently blocked from the primary content display.

Function button 26 defines a “Show Later” function, which will cause the secondary content to automatically be displayed at a later time (similar to a so-called snooze function) based on a default delay or one selected from sub-menu 27. This is similar to the reminder function except that the content will be displayed automatically at the defined time, whereas the reminder function will cuase a reminder to appear at that time, as described above.

Function button 28 defines a “More Info” function, which will cause a request for additional information related to the secondary content to be transmitted back to the secondary content server, or to another destination as defined in the secondary content itself. For example, the secondary content server may serve secondary content that includes an ad for a Volvo car. If the user selects the More Info button 28, a request URL is sent directly to www.volvo.com or back to the secondary server computer, as desired. In the case of a request sent directly to Volvo.com, then the secondary content server is unaware of the request and is essentially removed from further interaction with the user vis-à-vis the secondary content. If, however, the request URL is sent back to the secondary content server, then the secondary content server may log the request and then send the requested additional information back to the user computer. This is especially useful to enable the secondary content service to charge the sponsor of the secondary content—Volvo in this example—for providing additional advertisement information to the user.

The secondary content server may use the logged request information to build a profile regarding the user. For example, the user's profile generated by the secondary content server may indicate his interests as determined by the requests. The profile may also indicate which content the user has issued a blocking request for as described above. This profile information may be compiled for many users and used for subsequent marketing techniques as known in the art. The user's profile may also be used by the secondary content server to generate additional secondary content for transmission to the user. For example, Nissan Motors may pay a fee to the secondary content server to send Nissan content to all users showing an interest in cars, or perhaps to those users showing an interest in Volvo cars, etc.

Function button 30 defines a “Keep on Screen” function, which will cause the secondary content to remain on the display screen (i.e. frozen) until the user elects to close the window. This enables the user to navigate the web without losing the secondary content as in the prior art, and without actually saving it but by causing it to simply remain on the display screen.

As described herein, the present invention provides for a secondary content server (or a primary content server providing secondary content directly as described herein) to include or embed the function menu data along with the secondary content, which may be operated on by the user to control disposition of the secondary content as described and to optionally provide feedback data in the form of data requests or user action reports, etc. In addition to the function menu data being embedded along with the secondary content, an alternative embodiment of the invention provides for a software module such as a browser plug-in to execute on a user computing device to provide the same or similar functionality on secondary content that has not been modified to include the function menu data. When such a plug-in module is used on a user computer, it may operate on any type of secondary content from any provider, thus not requiring the secondary content to be adapted as in the previously described embodiment. The functionality of the present invention may thus be achieved in three manners: (1) by embedding the function menu data along with the secondary content, (2) by using a browser plug-in module to provide the same functionality without requiring the function data to be embedded in the secondary content, or (3) a combination of both techniques.

As previously mentioned, the secondary content service operating under this invention may utilize a rate structure for charging sponsors of the secondary content. This structure may multi-tiered, for example including a first tier based upon initial delivery of secondary content to a user computer. A second tier may be used when the user stores the secondary content on the user machine (an action which may be flagged and communicated back to the secondary content server for charging and record-keeping purposes). A third tier may be used if the user then requests additional content to be delivered (e.g. by selecting the More Info button on the function menu). Each tier may cause a different rate to be charged, for example the sponsor may be charged one cent for every ad delivered, two cents for every ad delivered and stored, and three cents for every ad that causes an additional information request, etc.

The secondary content service may be run by a search engine service as well as an advertising service. For example, in this embodiment, the search engine service serves secondary content that is related to the subject matter of the search terms. The user enters a search term on the search term form page, the term is returned to the service, and primary content in the form of search results is delivered back to the user computer. Secondary content, which may be advertisements and the like, is also served as previously described.

The present invention is particularly useful when a user is performing a specific research project on the Internet as opposed to just “surfing” the web. A surfer may be interested in clicking on the various ads and links that are presented on the screen, but a user who is performing a specific research project will not want to be distracted. Thus, by employing the present invention, the researches is able to control the delivery, storage and viewing of the secondary content pushed to his browser in the manner that he prefers. This may be applied to advertising, search engines, research, military applications, educational applications, and the like.

The present invention applies to traditional banner and pop up ads as secondary content, and it also applies to hyperlinks that are embedded within the primary content. The invention may be adapted to determine the presence of hyperlinks and act upon those links, such as by automatically storing them in a folder for subsequent use as described above. Furthermore, the present invention applies to any type of data such as packet data, continuous data feeds, streaming media, etc.

1. A method of managing online content comprising the steps of:
a user viewing a display device associated with a user computing device interconnected to a computer network;
a content server computer interconnected to the computer network providing content to the user computing device, said content comprising secondary content for display on the display device;
the user computing device receiving the secondary content provided by the content server computer;
the user computing device displaying primary content on the display device, and
performing a function with respect to the secondary content to control the disposition of the secondary content while maintaining display of the primary content on the display device.

2. The method of claim 1 wherein the function is defined in a default profile stored on the user computing device.

3. The method of claim 2 wherein the function is a default function automatically performed by the user computing device as a result of receiving the secondary content.

4. The method of claim 2 comprising the further steps of:
notifying the user that secondary content has been received;
requesting the user to allow the default function to be automatically performed or to allow the secondary content to be displayed on the display device.

5. The method of claim 1 further comprising the step of displaying the secondary content on the display device.

6. The method of claim 5 further comprising the step of
utilizing an input device associated with the user computing device to interact with the displayed secondary content to perform the function controlling disposition of the secondary content.

7. The method of claim 1 further comprising the steps of:
displaying a menu comprising a plurality of functions available for controlling the disposition of said secondary content;
selecting a function from the menu; and
the selected function utilized by the user computing device to control the disposition of the secondary content on the display device.

8. The method of claim 7 wherein the menu is part of the secondary content provided by the content server computer and displayed on the display device.

9. The method of claim 7 wherein the menu is caused to be displayed on the display device by a user interaction with the secondary content window.

10. The method of claim 9 wherein the user interaction with the secondary content is a right-click of a mouse input device.

11. The method of claim 7 wherein the function performed is storing the secondary content in a folder on a data storage device in the user computing device.

12. The method of claim 11 wherein the secondary content is sorted in a folder system according to topic of the secondary content.

13. The method of claim 11 wherein the secondary content is sorted in a folder system according to the sponsor of the secondary content.

14. The method of claim 11 wherein the secondary content is sorted in a folder system according to the time the secondary content has been received.

15. The method of claim 7 wherein the function performed is mapping the secondary content to an icon and placing the icon in a designated area in the display.

16. The method of claim 15 wherein the icon may be color-coded in accordance with a predetermined scheme related to a degree of interest indicated by the user.

17. The method of claim 7 wherein the function performed is linking the secondary content to a reminder file, wherein the reminder file specifies a subsequent time at which the user wishes to view the secondary content.

18. The method of claim 7 wherein the function performed is executing a blocking routine.

19. The method of claim 18 wherein the blocking routine defines that all secondary content from a defined content server computer is blocked from being received by the user computing device.

20. The method of claim 18 wherein the blocking routine defines that secondary content related to a defined topic from any content server computer is blocked from being received by the user computing device.

21. The method of claim 18 wherein the blocking routine defines that all secondary content from any content server computer is blocked from being received by the user computing device only during a defined time period.

22. The method of claim 18 wherein the blocking routine defines that all secondary content from any content server computer is blocked from being received by the user computing device only on defined days.

23. The method of claim 7 wherein the function performed is executing a delay routine wherein the secondary content is removed from the display device for a time period after which it is automatically re-displayed on the display device.

24. The method of claim 7 wherein the function performed is sending a request to the content server computer for additional content relevant to the secondary content.

25. The method of claim 7 wherein the function performed is causing the secondary content to be continuously displayed on the display device until selected by the user to be removed from display on the display device.

26. The method of claim 25 wherein the user selects the secondary content to be removed from display on the display device by using a user input device.

27. The method of claim 25 wherein the user selects the secondary content to be removed from display on the display device by predefining a time period.

28. The method of claim 24 further comprising the steps of:
the content server computer logging the request sent by the user computing device; and
the content server computer sending the requested additional content to the user computing device.

29. The method of claim 28 further comprising the step of generating a user profile based on a plurality of requests received by the content server computer.

30. The method of claim 29 further comprising the step of generating additional secondary content for subsequent transmission to the user computing device based on the user profile.

31. The method of claim 29 wherein additional information is obtained from a user via the user computing device and said additional information is added to the user profile.

32. The method of claim 28 further comprising the step of establishing a rate structure for charging a sponsor of said secondary content based upon information collected from the user computing device regarding an action taken by the user with respect to the secondary content.

33. The method of claim 32 wherein the rate structure is multi-tiered comprising:
a first tier based upon delivery of secondary content to a user computing device;
a second tier based upon a first action taken by a user with respect to the secondary content; and
a third tier based upon a request made by the user for additional information relevant to the secondary content.

34. The method of claim 1 wherein said secondary content comprises an advertisement.

35. The method of claim 1 wherein said secondary content comprises an instant message.

36. The method of claim 1 wherein said secondary content comprises an email message.

37. The method of claim 1 wherein said secondary content comprises destination-specific content.

38. The method of claim 1 wherein said secondary content comprises time-specific content.

39. A system for managing online content comprising:
a) a computer network;
b) a user computing device comprising:
network means for interconnecting with the computer network,
a display device, and
an input device;
c) a content server computer interconnected to the computer network, comprising means for providing content to the user computing device, said content comprising secondary content for display on the display device;
wherein the user computing device further comprises processing means operably connected to said network means, said display device, and said input device, and adapted to receive the secondary content provided by the content server computer and perform a function with respect to the secondary content to control the disposition of the secondary content while maintaining display of the primary content on the display device.

40. The system of claim 39 wherein user computing device further comprises data storage means for storing a default profile comprising a default function to be performed by the user computing device.

41. The system of claim 40 wherein the function is a default function automatically performed by the user computing device as a result of receiving the secondary content.

42. The system of claim 40 wherein the processing means is further adapted to:
notify the user that secondary content has been received; and
request the user to allow the default function to be automatically performed or to allow the secondary content to be displayed on the display device.

43. The system of claim 39 wherein the processing means is further adapted to display the secondary content on the display device.

44. The system of claim 43 wherein the processing means is further adapted to accept input commands from the input device to interact with the displayed secondary content to perform the function controlling disposition of the secondary content.

45. The system of claim 39 wherein the processing means is further adapted to:
display a menu comprising a plurality of functions available for controlling the disposition of said secondary content;
determine the selection of a function from the menu; and
utilize the selected function to control the disposition of the secondary content on the display device.

46. The system of claim 45 wherein the menu is part of the secondary content provided by the content server computer and displayed on the display device.

47. The system of claim 45 wherein the processing means is further adapted to cause the menu to be displayed on the display device as a result of a user interaction with the secondary content.

48. The system of claim 9 wherein the user interaction with the secondary content is a right-click of a mouse input device.

49. The system of claim 45 wherein the user computing device further comprises a data storage device comprising a folder system for storing the secondary content, and wherein the function performed is storing the secondary content in the folder system on the data storage device.

50. The system of claim 49 wherein the secondary content is sorted in the folder system according to topic of the secondary content.

51. The system of claim 49 wherein the secondary content is sorted in the folder system according to the sponsor of the secondary content.

52. The system of claim 49 wherein the secondary content is sorted in the folder system according to the time the secondary content has been received.

53. The system of claim 45 wherein the function performed is mapping the secondary content to an icon and placing the icon in a designated area in the display.

54. The system of claim 43 wherein the icon may be color-coded in accordance with a predetermined scheme related to a degree of interest indicated by the user.

55. The system of claim 45 wherein the function performed is linking the secondary content to a reminder file, wherein the reminder file specifies a subsequent time at which the user wishes to view the secondary content.

56. The system of claim 45 wherein the function performed is executing a blocking routine.

57. The system of claim 56 wherein the blocking routine defines that all secondary content from a defined content server computer is blocked from being received by the user computing device.

58. The system of claim 56 wherein the blocking routine defines that secondary content related to a defined topic from any content server computer is blocked from being received by the user computing device.

59. The system of claim 56 wherein the blocking routine defines that all secondary content from any content server computer is blocked from being received by the user computing device only during a defined time period.

60. The system of claim 56 wherein the blocking routine defines that all secondary content from any content server computer is blocked from being received by the user computing device only on defined days.

61. The system of claim 45 wherein the function performed is executing a delay routine wherein the secondary content is removed from the display device for a time period after which it is automatically re-displayed on the display device.

62. The system of claim 45 wherein the function performed is sending a request to the content server computer for additional content relevant to the secondary content.

63. The system of claim 45 wherein the function performed is causing the secondary content to be continuously displayed on the display device until selected by the user to be removed from display on the display device.

64. The system of claim 63 wherein the user selects the secondary content to be removed from display on the display device by using the user input device.

65. The system of claim 63 wherein the user selects the secondary content to be removed from display on the display device by predefining a time period.

66. The system of claim 65 wherein the content server computer comprises means for logging the request sent by the user computing device; and the content server computer further comprises means for sending the requested additional content to the user computing device.

67. The system of claim 66 wherein the content server computer further comprises means for generating a user profile based on a plurality of requests received by the content server computer.

68. The system of claim 67 wherein the content server computer further comprises means for generating additional secondary content for subsequent transmission to the user computing device based on the user profile.

69. The system of claim 67 wherein additional information is obtained from a user via the user computing device and said additional information is added to the user profile.
